(19) United States
(12) Patent Application Publication
(10) Pub. No.: US 2022/0162523 A1
(43) Pub. Date: May 26, 2022

(54) WATER-SOLUBLE UNIT DOSE ARTICLE COMPRISING A FATTY ALKYL ESTER ALKOXYLATE NON-IONIC SURFACTANT AND AN ALKOXYLATED ALCOHOL NON-IONIC SURFACTANT

(71) Applicant: The Procter & Gamble Company, Cincinnati, OH (US)

(72) Inventors: Hilde Francoise Louise ANDRIESSEN, Mol (BE); Kevin BEKAERT, Wemmel (BE); Jean-Pol BOUTIQUE, Gembloux (BE); Alice Michele BOUTOILLE, BRUXELLES (BE); Harry William BROENING, Milford, OH (US); Karel Jozef Maria DEPOOT, ANZEGEM VICHTE (BE); Phillip Kyle VINSON, Fairfield, OH (US)

(21) Appl. No.: 17/524,073

(22) Filed: Nov. 11, 2021

(30) Foreign Application Priority Data
Nov. 20, 2020 (EP) 20209068.4

(51) Int. Cl. C11D 1/83; C11D 11/00; C11D 17/04; C11D 3/20; C11D 3/43; C11D 3/37

(52) U.S. Cl. CPC C11D 1/83; C11D 11/0017; C11D 17/043; C11D 1/721; C11D 3/43; C11D 3/3753; C11D 3/2079

(57) ABSTRACT

A water-soluble unit dose article containing a non-soap anionic surfactant, a non-ionic surfactant and a method of use thereof.

### FIELD OF THE INVENTION

The present disclosure relates to a water-soluble unit dose article containing a non-soap anionic surfactant, a non-ionic surfactant and a method of making thereof.

### BACKGROUND OF THE INVENTION

Water-soluble unit dose articles are liked by consumers as they are convenient and efficient to use. Such water-soluble unit dose articles often comprise laundry detergent compositions. Without wishing to be bound by theory, when the water-soluble unit dose article is added to water, the film dissolves/disintegrates releasing the internal contents into the surrounding water to create a wash liquor.

Non-ionic surfactants are often added to detergent formulations to facilitate body soil cleaning from fabrics. Due to their effectiveness on such soils, it is preferred to add them at higher levels within liquid laundry detergent formulations. However, an issue with formulating higher levels of non-ionic surfactant is that it is challenging to manufacture liquid laundry formulations comprising high non-ionic levels into a water-soluble unit dose article at high line speeds in the plant, more particularly as they are very susceptible to liquid stringing and dripping. Such liquid stringing is the phenomoneon where a volume of liquid detergent is left still attached to the tip of the dispensing nozzle. This excess volume has a tendency to fall, or drip from the end of the nozzle at an undesired time, and can result in it being deposited into an area of the unit dose article where it is not desired such as in the area of the film used to seal the unit dose article. This can result in seal failures and premature rupture/unwanted opening of the unit dose article.

It was surprisingly found that high nonionic surfactant comprising formulations compatible with high line speeds are enabled through formulating a fatty alkyl ester alkoxylate non-ionic surfactant while controlling the level of alcohol alkoxylate nonionic surfactant, as such formulas have shown a decreased tendency to stringing and dripping, allowing faster line speeds accordingly.

### SUMMARY OF THE INVENTION

The present disclosure relates to a water-soluble unit dose article comprising a water-soluble film and a liquid laundry detergent composition, wherein the liquid laundry detergent composition comprises;
a. from 15% to 55% by weight of the liquid laundry detergent composition of a non-soap anionic surfactant;
b. from 2.5% to 30% by weight of the liquid laundry detergent composition of a non-ionic surfactant;
wherein the non-ionic surfactant comprises;
   (i) a fatty alkyl ester alkoxylate non-ionic surfactant according to structure (I);

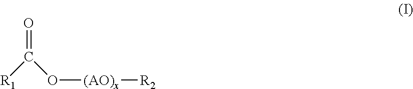

wherein, R₁ is a linear or branched alkyl chain having an average of from 8 to 18 carbon atoms; R₂ represents an alkyl chain comprising of from 1 to 6 carbon atoms, AO is an alkoxy group selected from ethoxy, propoxy, butoxy or mixed alkoxy groups; x is an average value of from 1 to 30;
   (ii) 15% or less by weight of the liquid laundry detergent composition of an alkoxylated alcohol non-ionic surfactant according to structure;

R₂—O-(EO)ₚ-H; (II)
wherein, EO is an ethoxylate chain; R₂ is a linear or branched alkyl chain having an average of from 8 to 18 carbon atoms; p is an average value of from 1-30.

The present disclosure also relates to a process of making the water-soluble unit dose article, comprising the steps of;
a. thermoforming a first water-soluble film in a mould to create an open cavity;
b. filling the open cavity with the liquid laundry detergent composition according to the present invention via at least one nozzle;
c. closing the filled open cavity with a second water-soluble film;
d. sealing the first water-soluble film and the second water-soluble film to create the water-soluble unit dose article, preferably wherein the films are sealed via heat sealing, solvent sealing, pressure sealing or a combination thereof, more preferably solvent sealing;
preferably, wherein the second water-soluble film is sealed to a third water-soluble film wherein one or more compartments are comprised between the second and third water-soluble films

### BRIEF DESCRIPTION OF THE DRAWINGS

FIG. 1 is a water-soluble unit dose article according to the present invention.

### DETAILED DESCRIPTION OF THE INVENTION

### Water-Soluble Unit Dose Article

The present disclosure relates to a water-soluble unit dose article comprising a water-soluble film and a liquid laundry detergent composition. The water-soluble film and the liquid detergent composition are described in more detail below.

The water-soluble unit dose article comprises the water-soluble film shaped such that the unit-dose article comprises at least one internal compartment surrounded by the water-soluble film. The unit dose article may comprise a first water-soluble film and a second water-soluble film sealed to one another such to define the internal compartment. The water-soluble unit dose article is constructed such that the detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments, or even at least four compartments. The compartments may be arranged in superposed orientation, i.e. one positioned on top of the other. In such an orientation the unit dose article will comprise at least three films, top, one or more middle, and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side. The unit dose article may comprise at least four compartments, three of the compartments may be smaller than the fourth compartment, and preferably the smaller compartments are superposed on the larger compartment. The superposed compartments preferably are orientated side-by-side.

In a multi-compartment orientation, the detergent composition according to the present invention may be comprised in at least one of the compartments. It may for example be comprised in just one compartment, or may be comprised in two compartments, or even in three compartments, or even in four compartments.

Each compartment may comprise the same or different compositions. The different compositions could all be in the same form, or they may be in different forms. The water-soluble unit dose article may comprise at least two internal compartments, wherein the liquid laundry detergent composition is comprised in at least one of the compartments, preferably wherein the unit dose article comprises at least three compartments, wherein the detergent composition is comprised in at least one of the compartments.

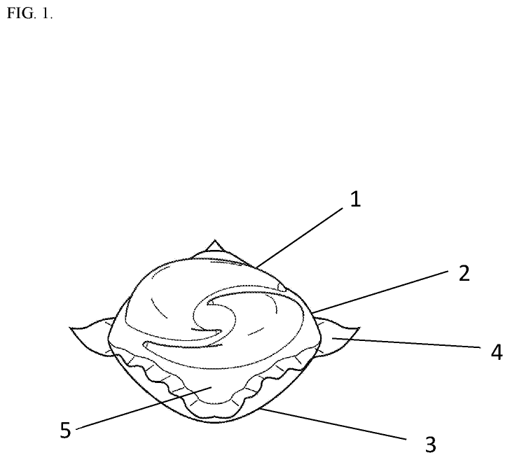

FIG. 1 discloses a water-soluble unit dose article (1) according to the present invention. The water-soluble unit dose article (1) comprises a first water-soluble film (2) and a second water-soluble film (3) which are sealed together at a seal region (4). The liquid laundry detergent composition (5) is comprised within the water-soluble soluble unit dose article (1).

Water-Soluble Film

The film of the present disclosure is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

5 grams ±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Preferably, the water-soluble film comprises polyvinyl alcohol homopolymer or polyvinylalcohol copolymer, preferably a blend of polyvinylalcohol homopolymers and/or polyvinylalcohol copolymers wherein the polyvinylalcohol copolymers preferably are selected from sulphonated and carboxylated anionic polyvinylalcohol copolymers especially carboxylated anionic polyvinylalcohol copolymers, most preferably wherein the water soluble film comprises a blend of a polyvinylalcohol homopolymer and a carboxylated anionic polyvinylalcohol copolymer.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

The film may be opaque, transparent or translucent. The film may comprise a printed area. The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof Any suitable level of aversive agent may be used in the film. Suitable levels include, but are not limited to, 1 to 5000 ppm, or even 100 to 2500 ppm, or even 250 to 2000 rpm.

Preferably, the water-soluble film or water-soluble unit dose article or both are coated in a lubricating agent, preferably, wherein the lubricating agent is selected from talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins or mixtures thereof.

Preferably, the water-soluble film, and each individual component thereof, independently comprises between 0 ppm and 20 ppm, preferably between 0 ppm and 15 ppm, more preferably between 0 ppm and 10 ppm, even more preferably between 0 ppm and 5 ppm, even more preferably between 0 ppm and 1 ppm, even more preferably between 0 ppb and 100 ppb, most preferably 0 ppb dioxane. Those skilled in the art will be aware of known methods and techniques to determine the dioxane level within water-soluble films and ingredients thereof.

### Liquid Laundry Detergent Composition

The water-soluble unit dose article comprises a liquid laundry detergent composition. The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules

The liquid laundry detergent composition can be used in a fabric hand wash operation or may be used in an automatic machine fabric wash operation.

The liquid laundry detergent composition comprises from 15% to 55% by weight of the liquid laundry detergent composition of a non-soap anionic surfactant. Preferably, the detergent composition comprises between 20% and 55%, more preferably between 25% and 50% by weight of the liquid laundry detergent composition of a non-soap anionic surfactant.

Preferably, the non-soap anionic surfactant comprises linear alkylbenzene sulphonate. Preferably, the linear alkylbenzene sulphonate comprises C₁₀-C₁₆ alkyl benzene sulfonate, C₁₁-C₁₄ alkyl benzene sulphonate or a mixture thereof. Preferably, the alkylbenzene sulphonate is an amine neutralized alkylbenzene sulphonate, an alkali metal neutralized alkylbenzene sulphonate or a mixture thereof. The amine is preferably selected from monoethanolamine, triethanolamine or mixtures thereof. The alkali metal is preferably selected from sodium, potassium, magnesium or a mixture thereof. Preferably, the liquid laundry detergent composition comprises between 1% and40%, preferably between 3% and 40%, more preferably between 6% and 35% by weight of the liquid laundry detergent composition of the linear alkylbenzene sulphonate.

Preferably, the non-soap anionic surfactant comprises an alkyl sulphate anionic surfactant wherein the alkyl sulphate anionic surfactant is selected from alkyl sulphate, an alkoxylated alkyl sulphate or a mixture thereof. The alkyl sulphate anionic surfactant may be a primary or a secondary alkyl sulphate anionic surfactant, or a mixture thereof, preferably a primary alkyl sulphate anionic surfactant. Preferably, the alkoxylated alkyl sulphate comprises ethoxylated alkyl sulphate, propoxylated alkyl sulphate, a mixed ethoxylated/propoxylated alkyl sulphate, or a mixture thereof, more preferably an ethoxylated alkyl sulphate. Preferably, the ethoxylated alkyl sulphate has an average degree of ethoxylation of between 0.1 to 5, preferably between 0.5 and 3. Preferably, the ethoxylated alkyl sulphate has an average alkyl chain length of between 8 and 18, more preferably between 10 and 16, most preferably between 12 and 15. Preferably, the alkyl chain of the alkyl sulphate anionic surfactant is linear, branched or a mixture thereof. Preferably, the branched alkyl sulphate anionic surfactant is a branched primary alkyl sulphate, a branched secondary alkyl sulphate, or a mixture thereof, preferably a branched primary alkyl sulphate, wherein the branching preferably is in the 2-position, or alternatively might be present further down the alkyl chain, or could be multi-branched with branches spread over the alkyl chain. The weight average degree of branching of alkyl sulphate anionic surfactant may be from 0% to 100% preferably from 0% to 95%, more preferably from 0% to 60%, most preferably from 0% to 20%. Alternatively, the weight average degree of branching of alkyl sulphate anionic surfactant may be from 70% to 100%, preferably from 80% to 90%. Preferably, the alkyl chain is selected from naturally derived material, synthetically derived material or mixtures thereof. Preferably, the synthetically derived material comprises oxo-synthesized material, Ziegler-synthesized material, Guerbet-synthesized material, Fischer-Tropsch—synthesized material, iso-alkyl synthesized material, or mixtures thereof, preferably oxo-synthesized material. Preferably, the liquid laundry detergent composition comprises between 1% and 35%, preferably between 3% and 30%, more preferably between 6% and 20% by weight of the liquid laundry detergent composition of the alkyl sulphate anionic surfactant.

Preferably, the non-soap anionic surfactant comprises linear alkyl benzene sulphonate and an alkoxylated alkyl sulphate, more preferably, wherein the weight ratio of linear alkylbenzene sulphonate to alkoxylated alkyl sulphate is from 1:2 to 9:1, preferably from 1:1 to 8:1, more preferably from 1:1 to 7:1, most preferably from 1:1 to 6:1.

The liquid laundry detergent composition comprises from 2.5% to 30% by weight of the liquid laundry detergent composition of a non-ionic surfactant. The non-ionic surfactant is described in more detail below.

Preferably, the weight ratio of non-soap anionic surfactant to non-ionic surfactant is from 1:1 to 13:1, preferably from 1.25:1 to 10:1, more preferably from 1.5:1 to 7.5:1.

Preferably, the liquid laundry detergent composition comprises a fatty acid, preferably a neutralized fatty acid soap, preferably a fatty acid salt, more preferably an amine neutralized fatty acid salt, wherein preferably the amine is an alkanolamine more preferably selected from monoethanolamine, diethanolamine, triethanolamine or a mixture thereof, more preferably monoethanolamine. The liquid detergent composition may comprise between 1.5% and 20%, between 2% and 15%, between 3% and 12%, or between 4% and 10% by weight of the liquid laundry detergent composition of fatty acid.

Preferably, the liquid laundry detergent composition comprises between 1% and 20%, preferably between 5% and 15% by weight of the liquid laundry detergent composition of water.

Preferably, the liquid laundry detergent composition comprises between 10% and 40%, preferably between 15% and 30% by weight of the liquid laundry detergent composition of a non-aqueous solvent, preferably wherein the non-aqueous solvent is selected from 1,2-propanediol, dipropylene glycol, tripropyleneglycol, glycerol, sorbitol, polyethylene glycol or a mixture thereof.

Preferably, the liquid laundry detergent composition comprises an adjunct ingredient selected from the group comprising builders, perfumes, enzymes, citrate, bleach, bleach catalyst, dye, hueing dye, brightener, cleaning polymers including alkoxylated polyamines and polyethyleneimines, soil release polymer, fabric care polymers including cationic hydroxyethyl celluloses and cationic polyglucans, surfactant, solvent, dye transfer inhibitors, chelant, encapsulated perfume, polycarboxylates, structurant, pH trimming agents, anti-oxidants including Ralox 35, and mixtures thereof.

Preferably, the laundry detergent composition comprises a further enzyme selected from the group comprising hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, xyloglucanases, mannanases and amylases, nuclease or mixtures thereof, preferably a further enzyme selected from the group comprising proteases, amylase, cellulase, lipases, xyloglucanases, mannanases, and mixtures thereof. Preferably the further enzyme is a lipase.

The term lipase as used herein, includes enzymes which catalyze the hydrolysis of fats (lipids). Lipases are a sub class of esterases. Lipases suitable in the present invention include phospholipases, acyltransferases or perhydrolases e.g. acyltransferases with homology to Candida antarctica lipase A, acyltransferase from Mycobacterium smegmatis, perhydrolases from the CE 7 family, and variants of the M. smegmatis perhydrolase in particular the S54V variant used in the commercial product Gentle Power Bleach from Huntsman Textile Effects Pte Ltd. Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa), cutinase from Humicola, e.g. H. insolens, lipase from strains of Pseudomonas (some of these now renamed to Burkholderia), e.g. P. alcaligenes or P. pseudoalcaligenes, P. cepacia, P. sp. strain SD705, P. wisconsinensis, GDSL-type Streptomyces lipases, cutinase from Magnaporthe grisea, cutinase from Pseudomonas mendocina, lipase from Thermobifida fusca, Geobacillus stearothermophilus lipase, lipase from Bacillus subtilis, and lipase from Streptomyces griseus and S. pristinaespiralis. Typically, the lipase enzyme is present in the composition in an amount from 0.001% to 0.03%, preferably from 0.0025% to 0.025% and more preferably from 0.005% to 0.02% by weight of the composition of enzyme active protein. Without wishing to be bound by theory, enzymes are supplied as a preparation comprising the enzyme and other ingredients. Enzymes per se are proteins that catalyse reactions. By enzyme active protein we herein mean enzyme that can actively catalyse the relevant reaction.

Preferably, the liquid laundry detergent composition has a pH between 6 and 10, more preferably between 6.5 and 8.9, most preferably between 7 and 8, wherein the pH of the liquid laundry detergent composition is measured as a 10% product concentration in demineralized water at 20° C.

The liquid laundry detergent composition may be Newtonian or non-Newtonian. Preferably, the liquid laundry detergent composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The decreased viscosity upon shear application for non-Newtonian liquids is thought to further facilitate liquid detergent dissolution. The liquid laundry detergent composition described herein can have any suitable viscosity depending on factors such as formulated ingredients and purpose of the composition.

### Non-Ionic Surfactant

The liquid laundry detergent composition for use within a water soluble laundry detergent unit dose article comprises from 2.5% to 30% by weight of the liquid laundry detergent composition of a non-ionic surfactant. Preferably, the liquid laundry detergent composition comprises from 3.5% to 20%, preferably from 5% to 15% by weight of the liquid laundry detergent composition of the non-ionic surfactant.

The non-ionic surfactant comprises a fatty alkyl ester alkoxylate non-ionic surfactant according to structure I;

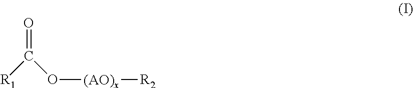

wherein, R₁ is a linear or branched alkyl chain having an average of from 8 to 18 carbon atoms. Preferably, the alkyl chain is selected from naturally derived material, synthetically derived material or mixtures thereof. Preferably, the synthetically derived material comprises oxo-synthesized material, Ziegler-synthesized material, Guerbet-synthesized material, Fischer-Tropsch—synthesized material, iso-alkyl synthesized material, or mixtures thereof. R₁ can be derived from a primary alcohol, a secondary alcohol, or mixtures thereof, preferably a primary alcohol. Most preferably R₁ is selected from a natural derived material, preferably soy bean oil, coconut oil or palm kernel oil derived materials, most preferably soy bean oil derived material. R₂ independently represents an alkyl comprising of from 1 to 6 carbon atoms, or a mixture thereof, preferably a C1 or C2 alkyl, or a mixture thereof, most preferably a C1 alkyl. AO represents an alkoxy chain selected from ethoxy, propoxy, butoxy or mixed alkoxy chains, preferably an ethoxy chain. X is an average value of from 1 to 30, preferably of between 4 and 18, more preferably between 7 and 16, most preferably between 10 and 14, representing the average number of units of ethylene oxide per unit of fatty alkyl ester alkoxylate.

A particularly preferred class of fatty alkyl ester alkoxylate nonionic surfactants are fatty methyl ester ethoxylate nonionic surfactants as represented by formula IA. Most preferably R₁ is selected from a natural derived material, preferably soy bean oil, coconut oil or palm kernel oil derived materials, most preferably soy bean oil derived material. EO represents an ethoxy chain. X preferably is an average value of between 4 and 18, more preferably between 7 and 16, even more preferably between 10 and 14, most preferably about 12.

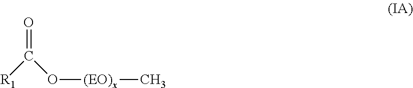

Examples of suitable fatty alkyl ester alkoxylate non-ionic surfactants include ethoxylated, propoxylated, butoxylated or mixed alkoxylated fatty alkyl ester nonionic surfactants, or mixtures thereof, preferably ethoxylated, propoxylated, butoxylated or mixed alkoxylated fatty methyl ester nonionic surfactants, or mixtures thereof (e.g. R₂ equals methyl in structure IA). More preferably the fatty alkyl ester preferably fatty methyl ester alkoxylate nonionic surfactant is an ethoxylated fatty alkyl ester preferably fatty methyl ester nonionic surfactant (i.e. AO equals EO in structure I). This class of fatty methyl ester ethoxylate nonionic surfactants is represented in structure IA above.

More preferably the fatty alkyl ester alkoxylate is selected from ethoxylated, propoxylated, butoxylated or mixed alkoxylated fatty alkyl ester alkoxylates, preferably fatty alkyl ester ethoxylates, more preferably fatty methyl ester ethoxylates, even more preferably fatty methyl ester ethoxylates selected from the group consisting of lauryl methyl ester ethoxylate, capryl methyl ester ethoxylate, decanoyl methyl ester ethoxylate, myristyl methyl ester ethoxylate, palmityl methyl ester ethoxylate, stearyl methyl ester ethoxylate, isostearyl methyl ester ethoxylate, oleyl methyl ester ethoxylate, linoleyl methyl ester ethoxylate, octyldecanoyl methyl ester ethoxylate, 2-heptylundecanoyl methyl ester ethoxylate, coconut oil fatty methyl ester ethoxylate, beef tallow fatty methyl ester ethoxylate, soybean oil fatty methyl ester ethoxylate and palm kernel oil fatty methyl ester ethoxylate, and mixtures thereof. Of these soybean oil fatty methyl ester ethoxylate, coconut oil fatty methyl ester ethoxylate, palm kernel oil fatty methyl ester ethoxylate, and mixtures thereof, are especially preferred. Most preferred are soybean oil fatty methyl ester ethoxylates, especially ethoxylated soybean oil fatty methyl ester ethoxylate with an average degree of ethoxylation between 10 and 14, especially about 12.

The liquid laundry detergent composition may comprise between 2.5% and 20%, preferably between 2.5% and 15%, more preferably between 3% and 10% by weight of the liquid laundry detergent composition of the fatty alkyl ester alkoxylate non-ionic surfactant.

Suitable examples of this first fatty alkyl ester alkoxylate non-ionic surfactant are amongst others commercially available from Huntsman under the Surfonic ME line-up. Examples include Surfonic ME550-SO (methyl ester ethoxylate derived from soybean oil—12 EO), Surfonic ME400 (methyl ester ethoxylate derived from coconut oil—10 EO) and Surfonic ME530-PS (methyl ester ethoxylate derived from palm kernel oil—12 EO). Most preferably the first fatty alkyl ester alkoxylate non-ionic surfactant comprises a soybean oil derived alkyl chain such as commercially available as Surfonic ME550-SO.

The non-ionic surfactant comprises 15% or less by weight of the liquid laundry detergent composition of an alkoxylated alcohol non-ionic surfactant according to structure;

(II) R₂—O-(EO)ₚ-H; (II)

wherein, EO is an ethoxylate chain. Preferably, the alkyl chain is selected from naturally derived material, synthetically derived material or mixtures thereof, most preferably naturally derived material. Preferably, the synthetically derived material comprises oxo-synthesized material, Ziegler-synthesized material, Guerbet-synthesized material, Fischer-Tropsch—synthesized material, iso-alkyl synthesized material, or mixtures thereof.

R₂ is a linear or branched alkyl chain having an average of from 8 to 18 carbon atoms, preferably a linear alkyl chain.

p is an average of from 1-30.

More preferably, the alkoxylated alcohol non-ionic surfactant has the formula;

R₂—O-(EO)ₚ-H (II)

wherein, EO is an ethoxylate group.

p is an average from 5 to 12, preferably from 6 to 10, more preferably from 7 to 9, representing the average number of units of ethylene oxide per unit of alcohol;

R₂ is a linear or branched alkyl chain having an average of from 8 to 18 carbon atoms, preferably from 9 to 15 carbon atoms, more preferably from 10 to 14 carbon atoms. Preferably, the alkyl chain is selected from naturally derived material, synthetically derived material or mixtures thereof, more preferably naturally derived material. Preferably, the synthetically derived material comprises oxo-synthesized material, Ziegler-synthesized material, Guerbet-synthesized material, Fischer-Tropsch—synthesized material, iso-alkyl synthesized material, or mixtures thereof.

The liquid laundry detergent composition may comprise between 0% and 12%, preferably between 2% and 6% by weight of the liquid laundry detergent composition of the alkoxylated alcohol non-ionic surfactant.

The weight ratio of the fatty alkyl ester alkoxylate non-ionic surfactant to the alkoxylated alcohol non-ionic surfactant is preferably from 1:1 to 7:1, preferably from 1:1 to 5:1, more preferably from 1:1 to 3:1.

The fatty alkyl ester alkoxylate non-ionic surfactant may be added straight to the liquid laundry detergent composition. Alternatively, the fatty alkyl ester alkoxylate non-ionic surfactant may first be mixed with other ingredients to create a premix. This premix comprising the fatty alkyl ester alkoxylate non-ionic surfactant may be added to the liquid laundry detergent composition. Alternatively, part of the fatty alkyl ester alkoxylate non-ionic surfactant may be added straight to the liquid laundry detergent composition, and the remainder may be added as part of a premix to the liquid laundry detergent composition. Equally, the alkoxylated alcohol non-ionic surfactant, if present, may be added straight to the liquid laundry detergent composition, may be added as part of a premix, or partially added straight and partially added as part of a premix.

### Process of Making

Those skilled in the art will be aware of standard techniques to make the liquid laundry detergent composition and the water-soluble unit dose article according to the present invention. Those skilled in the art will also be aware of standard techniques and methods to make the ingredients of the liquid laundry detergent composition of the present disclosure.

A preferred process for making the water-soluble unit dose article according to the present disclosure comprises the steps of;
a. thermoforming a first water-soluble film in a mould to create an open cavity;
b. filling the open cavity with the liquid laundry detergent composition according to the present invention via at least one nozzle;
c. closing the filled open cavity with a second water-soluble film;
d. sealing the first water-soluble film and the second water-soluble film to create the water-soluble unit dose article, preferably wherein the films are sealed via heat sealing, solvent sealing, pressure sealing or a combination thereof, more preferably solvent sealing.

The second water-soluble film may be sealed to a third water-soluble film wherein one or more compartments are comprised between the second and third water-soluble films. Preferably, solvent sealing is achieved using a solvent solution wherein the solvent solution comprises water, polyvinylalcohol or a mixture thereof, preferably at least 95% by weight of the solvent solution is water.

Preferably, the process is a continuous process. Preferably the first water-soluble film and the second water-soluble films move at a speed of 0.5 meters per minute (m/mire) to about 50 m/min, or from about 1 m/min to about 20 m/min, or from about 5 m/min to about 12 m/min.

Those skilled in the art will be aware of suitable nozzles to use. The nozzle will have an aperture through which the liquid laundry detergent composition will flow ahead of entering the open cavity. The aperture preferably has a cross-sectional area between 2 mm² and 30 mm². The aperture may be circular or non-circular in shape. The aperture may be circular and have a diameter of between 2 mm and 3.5 mm, preferably between 2.5 mm and 3 mm.

### Process of Use

A further aspect of the present disclosure is a process of laundering fabrics comprising the steps of diluting between 200 and 3000 fold, preferably between 300 and 2000 fold, the water-soluble unit dose article according to the present invention with water to make a wash liquor, contacting fabrics to be treated with the wash liquor.

### EXAMPLES

The liquid stringing and overall rheology impact of addition of a mixed fatty alkyl ester alkoxylate (Surfonic ME550-SO) alkoxylated alcohol nonionic surfactant according to the invention on top of liquid laundry detergent formulations suitable for use in water soluble unit dose articles, the liquid laundry detergent formulations comprising different levels of ethoxylated alcohol nonionic surfactants, has been assessed using the liquid stringing and rheology test methods described herein.

### Test Method:

### Liquid Stringing

The liquid stringing profile of the liquid laundry detergent compositions was assessed by measuring the breakup time of a capillary formed upon extension of a test sample to a certain strain using a Haake Caber I extensional rheometer (Caber:capillary break-up extensional rheometer). The sample diameter was set to 6 mm, initial sample height to 3 mm, final sample height to 17.27 mm, stretch profile was set to linear and strike time set on 100 ms. A shorter capillary breakup time indicates a lower degree of liquid stringing and hence reduced risk of liquid detergent being dosed onto the seal areas of a water soluble unit dose article.

### Rheology Profile:

The rheological profile of the liquid laundry detergent compositions was obtained using a TA Rheometer AR2000 at room temperature (25° C.). Pre-shear of samples was carried out at 50 s-1 for 30 s, afterwards the shear rate was continuously increased from 0.1 s-1-2000 s-1 over 7 minutes. The viscosity values at 0.5/s, 20/s and 1000 s were consequently reported. Shear thinning rheology profiles are preferred as a decreased high shear viscosity value facilitates dosing hence maximizing line speed during manufacture while an increased low shear viscosity will aid prevention of detergent dripping at the end of dosing liquid detergent into a water soluble pouch cavity hence again reducing the risk of liquid detergent being dosed onto the seal areas of a water soluble unit dose article.

### Test Materials:

Table 1 summarizes the individual liquid laundry detergent test compositions, suitable to be formulated into water soluble unit dose articles. Comparative compositions 1 and 2 do not comprise the fatty alkyl ester alkoxylate nonionic surfactant according to the invention and differ in alcohol ethoxylate nonionic surfactant level while keeping the total surfactant level constant through rebalancing alcohol ethoxylate nonionic surfactant and non-soap anionic surfactant levels, and in monoethanolamine level which is used as a pH trimming agent to enable a constant finished product pH. Inventive composition 1 comprises the fatty alkyl ester alkoxylate nonionic surfactant in combination with a low level of an ethoxylated alcohol nonionic surfactant, hence is a formulation according to the invention. Inventive composition 1 matches comparative composition 1 with 10% of propanediol solvent being replaced by the fatty alkyl ester alkoxylate nonionic surfactant. Comparative composition 3 comprises the fatty alkyl ester alkoxylate nonionic surfactant in combination with a level exceeding our claimed limits of an ethoxylated alcohol nonionic surfactant, hence is a formulation outside the scope of the invention. Comparative composition 3 matches comparative composition 2 with 10% of propanediol solvent being replaced by the fatty alkyl ester alkoxylate nonionic surfactant. Inventive composition 2 matches comparative composition 2 but had 10% alcohol ethoxylate nonionic surfactant replaced by 10% fatty alkyl ester ethoxylate nonionic surfactant and as such represents a formula with an intermediate alcohol ethoxylate nonionic surfactant level still within the limits of our invention.

TABLE 1
Detergent formulations

| | Com- | Inven- | Com- | Com- | Inven- |
|---|---|---|---|---|---|
| | parative | tive | parative | parative | tive |
| | Compo- | Compo- | Compo- | Compo- | Compo- |
| | sition | sition | sition | sition | sition |
| 100% active | 1 | 1 | 2 | 3 | 2 |
| Neodol 24/7 | 5.0 | 5.0 | 20.0 | 20.0 | 10.0 |
| ethoxylated | | | | | |
| alcohol | | | | | |
| nonionic | | | | | |
| surfactant | | | | | |
| Surfonic | — | 10.0 | — | 10.0 | 10.0 |
| ME550-S0 | | | | | |
| (Fatty | | | | | |
| Methyl | | | | | |
| Ester | | | | | |
| Ethoxylate | | | | | |
| nonionic | | | | | |
| surfactant)* | | | | | |
| Linear | 20.4 | 20.4 | 12.4 | 12.4 | 12.4 |
| alkylbenzene | | | | | |
| sulphonic | | | | | |
| acid | | | | | |
| MEA-AE3S | 15.0 | 15.0 | 8.0 | 8.0 | 8.0 |
| Fatty acid | 6.1 | 6.1 | 6.1 | 6.1 | 6.1 |
| Lutensol | 0.5 | 0.5 | 0.5 | 0.5 | 0.5 |
| XL100 | | | | | |
| Citric acid | 0.7 | 0.7 | 0.7 | 0.7 | 0.7 |
| 1,2- | 16.2 | 6.2 | 19.1 | 9.1 | 19.3 |
| propanediol | | | | | |
| Glycerol | 5.0 | 5.0 | 5.0 | 5.0 | 5.0 |
| Dipropyleneglycol | 2.0 | 2.0 | 2.0 | 2.0 | 2.0 |
| Tripropyleneglycol | 0.1 | 0.1 | 0.1 | 0.1 | 0.1 |
| Monoethanolamine | 10.9 | 10.1 | 7.4 | 7.4 | 7.4 |
| (pH | | | | | |
| trimming | | | | | |
| agent) | | | | | |
| Water | 8.5 | 8.5 | 8.5 | 8.5 | 8.5 |
| Ethoxylated | 1.7 | 1.7 | 1.7 | 1.7 | 1.7 |
| polyethyleneimine** | | | | | |
| Amphiphilic graft | 2.6 | 2.6 | 2.6 | 2.6 | 2.6 |
| copolymer*** | | | | | |
| HEDP | 2.4 | 2.4 | 2.4 | 2.4 | 2.4 |
| Hydrogenated | 0.1 | 0.1 | 0.1 | 0.1 | 0.1 |
| castor oil | | | | | |
| Protease | 0.09 | 0.09 | 0.09 | 0.09 | 0.09 |
| (54.5 mg/g) | | | | | |
| MgCl2 | 0.3 | 0.3 | 0.3 | 0.3 | 0.3 |
| K2SO3 | 0.4 | 0.4 | 0.4 | 0.4 | 0.4 |
| Na-formate | 0.1 | 0.1 | 0.1 | 0.1 | 0.1 |
| Minors | Balance | Balance | Balance | Balance | Balance |
| (perfume, | to | to | to | to | to |
| dyes, | 100% | 100% | 100% | 100% | 100% |
| antioxidant, . . .) | | | | | |
| pH (as 10% | 7.4 | 7.4 | 7.4 | 7.4 | 7.4 |
| aqueous | | | | | |
| solution) | | | | | |

*derived from soybean oil, 12 EO
**ethoxylated polyethyleneimine having an average degree of ethoxylation of 20 per EO chain and a polyethyleneimine backbone with MW of about 600
***polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains

### Test Results:

The capillary break-up time and rheology upon shear rate data summarized in table 2 show that liquid detergent compositions lacking the fatty alkyl ester ethoxylate nonionic surfactant according to the invention (Comparative compositions 1 and 2) have a significantly inferior stringing profile compared to compositions comprising the fatty alkyl ester ethoxylate nonionic surfactant according to the invention. This inferior stringing profile requires the manufacturing apparatus upon manufacturing to run at a decreased line speed in order to prevent liquid detergent ending up onto the seal area which would negatively impact finished product quality, especially in view of liquid leakage control. Increasing the alcohol ethoxylate nonionic surfactant content within compositions comprising the fatty alkyl ester ethoxylate nonionic surfactant according to the invention reduces however the shear thinning properties of the liquid detergent composition, with alcohol ethoxylate levels exceeding the upper limit according to the invention (Comparative composition 3) even rendering the liquid detergent composition

Newtonian. This decreased low shear viscosity profile renders the liquid detergent more susceptible to dripping from the dosing tip at the end of a filling cycle, again risking the contamination of the seal area and as such requiring the manufacturing line to run at a decreased line speed in order to secure finished product quality. As such liquid detergent compositions comprising a fatty alkyl ester ethoxylate nonionic surfactant according to the invention, while controlling the level of alcohol ethoxylate nonionic surfactant within the limits according to the invention, show superior stringing and dripping control while facilitating dosing during manufacturing, enabling maximizing converter line speeds during manufacturing while still securing finished product quality accordingly.

TABLE 2
capillary break-up time data (the lower, the better)

| | viscosity @ | viscosity | viscosity | Breakup |
|---|---|---|---|---|
| Test formulations | 0.5/s | @20/s | @1000/s | time |
| Comparative | 2464 mPas | 692 mPas | 489 mPas | 1.5s |
| composition 1 | | | | |
| Inventive composition 1 | 1572 mPas | 793 mPas | 646 mPas | 0.8s |
| Comparative | 1193 mPas | 420 mPas | 300 mPas | 1.6s |
| composition 2 | | | | |
| Comparative | 275 mPas | 280 mPas | 280 mPas | 0.4s |
| composition 3 | | | | |
| Inventive composition 2 | 745 mPas | 388 mPas | 296 mPas | 0.6s |

The following are examples of multi-compartment water soluble unit dose laundry articles comprising a larger bottom compartment while having two smaller compartments in a side by side configuration superposed on top of the bottom compartment, following the Ariel 3-in-1 Pods design, as commercially available in the UK in January 2020 and as visualized in FIG. 1. The overall water-soluble unit dose articles comprise exemplary liquid laundry formulations (Tables 2 and 3) comprising a surfactant system comprising a mixed fatty alkyl ester alkoxylate/alkoxylated alcohol nonionic surfactant according to the present invention. The below compositions are enclosed in a polyvinyl alcohol based water soluble film, more specifically a water soluble film comprising a blend of a polyvinylalcohol homopolymer and a carboxylated anionic polyvinylalcohol copolymer, as received from the MonoSol company.

TABLE 2

| | | Bottom | Top | Top |
|---|---|---|---|---|
| | Full | compart- | compart- | compart- |
| | article | ment | ment | ment |
| | Compo- | Compo- | Compo- | Compo- |
| | sition | sition | sition 1 | sition 2 |
| Ingredients | (wt %) | (wt %) | (wt %) | (wt %) |
| Volume | 20.7 ml | 17.5 ml | 1.6 m1 | 1.6 m1 |
| Surfonic ME550-S0 (Fatty | 4.8 | 4.9 | 4.6 | 4.3 |
| Methyl Ester Ethoxylate | | | | |
| nonionic surfactant) | | | | |
| Fatty alcohol ethoxylate non- | 3.5 | 3.7 | 3.0 | 1.9 |
| ionic surfactant, | | | | |
| C₁₂₋₁₄ average | | | | |
| degree of ethoxylation of 7 | | | | |
| Lutensol XL100 | 0.4 | 0.5 | — | — |
| Linear C₁₁₋₁₄ alkylbenzene | 24.5 | 24.9 | 23.2 | 22.3 |
| sulphonate | | | | |
| AE3S Ethoxylated alkyl | 10.2 | 10.3 | 9.8 | 9.3 |
| sulphate with an average | | | | |
| degree of ethoxylation of 3 | | | | |
| Citric acid | 0.6 | 0.6 | 0.6 | 0.6 |
| Palm Kernel Fatty acid | 4.7 | 4.8 | 4.5 | 4.3 |
| Nuclease enzyme* | 0.012 | 0.014 | — | — |
| (wt % active protein) | | | | |
| Protease enzyme | 0.065 | 0.076 | — | — |
| (wt % active protein) | | | | |
| Amylase enzyme | 0.005 | 0.007 | — | — |
| (wt % active protein) | | | | |
| Xyloglucanese enzyme | 0.005 | — | 0.073 | — |
| (wt % active protein) | | | | |
| Mannanase enzyme | 0.004 | 0.004 | — | — |
| (wt % active protein) | | | | |
| Lipase enzyme | 0.008 | — | 0.098 | — |
| (wt % active protein)** | | | | |
| Ethoxylated polyethyl- | 1.9 | 1.9 | 1.8 | 1.7 |
| eneimine | | | | |
| Amphiphilic graft | 2.2 | 2.6 | — | — |
| copolymer | | | | |
| Zwitterionic polyamine | 1.9 | 1.9 | 1.8 | 1.7 |
| Anionic polyester | 0.3 | — | — | 4.4 |
| terephthalate*** | | | | |
| HEDP | 2.0 | 2.1 | 2.0 | 1.8 |
| Brightener 49 | 0.3 | 0.4 | 0.01 | 0.01 |
| Silicone anti-foam | 0.3 | 0.3 | — | — |
| Hueing dye**** | 0.05 | — | 0.69 | — |
| 1,2 PropaneDiol | 13.5 | 12.7 | 12.7 | 23.3 |
| Glycerine | 4.0 | 3.2 | 10.9 | 6.1 |
| Sorbitol | 0.4 | 0.06 | 4.6 | — |
| Monoethanolamine | 9.6 | 9.7 | 9.1 | 8.7 |
| K2SO3 | 0.1 | 0.1 | 0.03 | 0.4 |
| MgCl2 | 0.3 | 0.3 | 0.3 | 0.3 |
| water | 10.6 | 10.9 | 9.4 | 8.2 |
| Hydrogenated castor oil | 0.1 | 0.1 | — | 0.1 |
| Perfume | 2.7 | 3.2 | — | — |
| Aesthetic dye & Minors | Balance | Balance | Balance | Balance |
| (incl. preservative) | to | to | to | to |
| | 100 | 100 | 100 | 100 |
| pH (10% product | 7.4 | 7.4 | 7.4 | 7.4 |
| concentration | | | | |
| in demineralized water | | | | |
| at 20° C.) | | | | |

*Nuclease enzyme is as claimed in co-pending European application 19219568.3
**added as a premix of composition: (1 wt % lipase enzyme, 33 wt % sorbitol, 21 wt % water, 45wt % glycerin) - premix components reflected in above formula composition
***added as a premix of composition: (20 wt % anionic polyester terephthalate, 56 wt % 1,2-propanediol, 8 wt % water, 16 wt % glycerin) - premix components reflected in above formula composition
****added as a premix of composition: (12 wt % hueing dye, 71.5 wt % 1,2-propanediol, 16.5% Fatty alcohol ethoxylate non-ionic surfactant) - premix components reflected in above formula composition

TABLE 3

| | | Bottom | Top | Top |
|---|---|---|---|---|
| | Full | com- | com- | com- |
| | article | partment | partment | partment |
| | Com- | Com- | Com- | Com- |
| | position | position | position 1 | position 2 |
| Ingredients | (wt %) | (wt %) | (wt %) | (wt %) |
| Volume | 22 ml | 18.8 ml | 1.6 m1 | 1.6 m1 |
| Gram (excl film) | 23.4 g | 19.9 g | 1.8 g | 1.7 g |
| Surfonic ME550-S0 (Fatty | 4.0 | 3.9 | 3.1 | 5.3 |
| Methyl Ester Ethoxylate | | | | |
| nonionic surfactant) | | | | |
| Fatty alcohol ethoxylate | 2.9 | 3.0 | 1.4 | 3.3 |
| nonionic surfactant, C₁₂₋₁₄ | | | | |
| average | | | | |
| degree of ethoxylation of 7 | | | | |
| Linear C₁₁₋₁₄ alkylbenzene | 26.3 | 27.1 | 15.9 | 27.1 |
| sulphonate | | | | |
| AE3S Ethoxylated alkyl | 7.9 | 7.7 | 6.6 | 11.3 |
| sulphate with an average | | | | |
| degree of ethoxylation of 3 | | | | |
| Citric acid | 0.6 | 0.6 | 0.4 | 0.7 |
| Palm Kernel Fatty acid | 9.3 | 10.2 | 3.0 | 5.2 |
| Protease enzyme | 0.06 | 0.07 | — | — |
| (wt % active protein) | | | | |
| Amylase enzyme | 0.003 | 0.004 | — | — |
| (wt % active protein) | | | | |
| Nuclease enzyme* | 0.01 | 0.01 | — | — |
| (wt % active protein) | | | | |
| Ethoxylated polyethyl- | 1.5 | 1.5 | 1.2 | 2.1 |
| eneimine | | | | |
| Zwitterionic polyamine | 1.5 | 1.5 | 1.2 | 2.1 |
| Anionic polyester | 0.3 | — | 4.4 | — |
| terephthalate*** | | | | |
| Cationic hydroxyethyl | 0.5 | — | 7.1 | — |
| cellulose***** | | | | |
| HEDP | 0.8 | 0.7 | 1.3 | 2.3 |
| Brightener 49 | 0.3 | 0.3 | 0.01 | 0.02 |
| Silicone anti-foam | 0.3 | 0.3 | — | — |
| Hueing dye**** | 0.05 | — | — | 0.7 |
| 1,2 PropaneDiol | 13.0 | 11.8 | 23.1 | 17.4 |
| Glycerine | 5.7 | 5.9 | 5.3 | 3.2 |
| Sorbitol | 0.02 | 0.03 | — | — |
| PPG400 | 0.8 | — | 11.4 | — |
| Monoethanolamine | 9.3 | 9.4 | 6.2 | 10.6 |
| K25O3 | 0.4 | 0.4 | 0.4 | 0.04 |
| MgCl2 | 0.2 | 0.1 | 0.2 | 0.3 |
| Sodium formate | 0.06 | 0.07 | — | — |
| water | 10.1 | 10.5 | 7.1 | 7.5 |
| Hydrogenated castor oil | 0.1 | 0.1 | 0.08 | 0.08 |
| Acusol 880 | 0.02 | — | 0.2 | — |
| Perfume | 2.7 | 3.2 | — | — |
| Ralox 35****** | 0.3 | 0.3 | — | — |
| Polyacrylate based perfume | 0.4 | 0.4 | — | — |
| capsules | | | | |
| Aesthetic dye & Minors | Balance | Balance | Balance | Balance |
| (incl. preservative) | to | to | to | to |
| | 100 | 100 | 100 | 100 |
| pH (10% product | 7.4 | 7.4 | 7.4 | 7.4 |
| concentration | | | | |
| in demineralized water | | | | |
| at 20° C.) | | | | |

*Nuclease enzyme is as claimed in co-pending European application 19219568.3
**added as a premix of composition: (l wt % lipase enzyme, 33wt % sorbitol, 21 wt % water, 45wt % glycerin) - premix components reflected in above formula composition
***added as a premix of composition: (20 wt % anionic polyester terephthalate, 56 wt % 1,2-propanediol, 8 wt % water, 16 wt % glycerin) - premix components reflected in above formula composition
****added as a premix of composition: (12 wt % hueing dye, 71.5 wt % 1,2-propanediol, 16.5% Fatty alcohol ethoxylate non-ionic surfactant) - premix components reflected in above formula composition
*****added as a premix of composition: (37 wt % cationic hydroxyethyl cellulose, 60 wt % PPG400, 3 wt % Acusol 880)^{a} - premix components reflected in above formula composition
^{a}alternative premix: (37 wt % cationic hydroxyethyl cellulose, 60 wt % Surfonic ME550-S0, 3 wt % Acusol880)
******added as a premix of composition: (40 wt % Ralox PA35, 60 wt % Fatty alcohol ethoxylate non-ionic surfactant e.g. C12-14E07)^{b} - premix components reflected in above formula composition
^{b}alternative premix: (20 wt % Ralox PA35, 80 wt % Surfonic ME550-S0)

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble unit dose article comprising a water-soluble film and a liquid laundry detergent composition, wherein the liquid laundry detergent composition comprises:
a. from about 15% to about 55% by weight of the liquid laundry detergent composition of a non-soap anionic surfactant;
b. from about 2.5% to about 30% by weight of the liquid laundry detergent composition of a non-ionic surfactant,
wherein the non-ionic surfactant comprises:
(i) a fatty alkyl ester alkoxylate non-ionic surfactant according to structure (I): 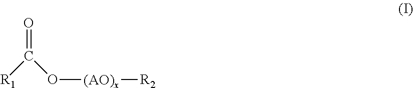
wherein:
R₁ is a linear or branched alkyl chain having an average of from about 8 to about 18 carbon atoms,
R₂ represents an alkyl chain comprising of from about 1 to about 6 carbon atoms,
AO is an alkoxy group selected from ethoxy, propoxy, butoxy or mixed alkoxy groups;
x is an average value of from about 1 to about 30;
(ii) about 15% or less by weight of the liquid laundry detergent composition of an alkoxylated alcohol non-ionic surfactant according to structure (II)
R₂—O-(EO)ₚ-H (II)
wherein:
EO is an ethoxylate chain;
R₂ is a linear or branched alkyl chain having an average of from about 8 to about 18 carbon atoms; and
p is an average value from about 1 to about 30.

2. The water-soluble unit dose article according to claim 1, wherein the liquid laundry detergent composition comprises from about 3.5% to about 20% by weight of the liquid laundry detergent composition of the non-ionic surfactant.

3. The water-soluble unit dose article according to claim 1 wherein the fatty alkyl ester alkoxylate non-ionic surfactant is according to formula (I); wherein R₁ is selected from a naturally derived material, and R₂ represents a C1 or C2 alkyl, or a mixture thereof, and AO is selected from an ethoxy group (EO) and x is an average value of between 4 and 18.

4. The water-soluble unit dose article according to claim 3, wherein R₁ is selected from soybean oil, coconut oil or palm kernel oil derived materials.

5. The water-soluble unit dose article according to claim 4, wherein R₁ is a soybean oil derived alkyl; R₂ is methyl, AO is EO, and x is from 10 to 14.

6. The water-soluble unit dose article according to claim 1, wherein the alkoxylated alcohol non-ionic surfactant has the formula;
R₂—O-(EO)ₚ-H (II)
wherein EO is an ethoxylate group;
p is an average from about 5 to about 12;
R₂ is a linear or branched alkyl chain having an average of from about 8 to about 18 carbon atoms.

7. The water-soluble unit dose article according to claim 1 comprising between about 2.5% and about 20% by weight of the liquid laundry detergent composition of the fatty alkyl ester alkoxylate non-ionic surfactant.

8. The water-soluble unit dose article according to claim 1 comprising between about 0% and about 12% by weight of the liquid laundry detergent composition of the alkoxylated alcohol non-ionic surfactant.

9. The water-soluble unit dose article according to claim 1, wherein the weight ratio of the fatty alkyl ester alkoxylate non-ionic surfactant to the alkoxylated non-ionic surfactant is from about 1:1 to about 7:1.

10. The water-soluble unit dose article according to claim 1 wherein the liquid laundry detergent composition comprises between about 20% and about 55%, by weight of the liquid laundry detergent composition, of a non-soap anionic surfactant.

11. The water-soluble unit dose article according to claim 10, wherein the non-soap anionic surfactant comprises linear alkyl benzene sulphonate and an alkoxylated alkyl sulphate.

12. The water-soluble dose article according to claim 11 wherein the weight ratio of linear alkylbenzene sulphonate to alkoxylated alkyl sulphate is from 1:2 to 9:1.

13. The water-soluble unit dose article according to claim 10, wherein the weight ratio of non-soap anionic surfactant to non-ionic surfactant is from 1:1 to 13:1.

14. The water-soluble unit dose article according to claim 1, wherein the liquid laundry detergent composition further comprises a fatty acid.

15. The water-soluble unit dose article according to claim 1, wherein the liquid laundry detergent further comprises between about 1% and about 20%, by weight of the liquid laundry detergent composition, of water.

16. The water-soluble unit dose article according to claim 1, wherein the liquid laundry detergent composition comprises between about 10% and about 40%, by weight of the liquid laundry detergent composition, of a non-aqueous solvent.

17. The water-soluble unit dose article according to claim 16 wherein the non-aqueous solvent is selected from the group consisting of 1,2-propanediol, dipropylene glycol, tripropyleneglycol, glycerol, sorbitol, polyethylene glycol, and mixtures thereof

18. The water-soluble unit dose article according to claim 1, wherein the water-soluble film comprises a polyvinyl alcohol polymer.

19. The water-soluble unit dose article according to claim 18, wherein the water-soluble film comprises a polyvinyl alcohol homopolymer, a polyvinyl alcohol copolymer, or a mixture thereof

20. A process of making the water-soluble unit dose article according to claim 1, comprising the steps of:
a. thermoforming a first water-soluble film in a mould to create an open cavity;
b. filling the open cavity with the liquid laundry detergent composition according to claim 1 via at least one nozzle;
c. closing the filled open cavity with a second water-soluble film;
d. sealing the first water-soluble film and the second water-soluble film to create the water-soluble unit dose article.
